(19) United States
(12) Patent Application Publication
(10) Pub. No.: US 2026/0355905 A1
(43) Pub. Date: Nov. 12, 2026

(54) SPLITTER FOR ICE BLASTING SYSTEMS

(71) Applicant: Nu-Ice Age, Inc., Clarklake, MI (US)

(72) Inventors: Edward L. Cooper, Clarklake, MI (US); Steven J. Hayes, Addison, MI (US)

(21) Appl. No.: 19/134,381

(22) PCT Filed: Dec. 6, 2023
(86) PCT No.: PCT/US2023/082637

§ 371 Date: May 30, 2025

Related U.S. Application Data
(60) Provisional application No. 63/430,751, filed on Dec. 7, 2022.

(51) Int. Cl. B24C 9/00; B02C 19/00; B24C 1/00

(52) U.S. Cl. CPC B24C 9/006; B02C 19/0043; B24C 1/003

(57) ABSTRACT

A splitter for splitting ice pieces of an ice blasting system includes a splitter housing defining a passageway and a central axis and having an inlet end and an outlet end and defining a cavity therein. A plurality of first blades are disposed at a first axial location within the cavity and extend across the passageway. A plurality of second blades are disposed at a second axial location downstream from the first axial location and within the cavity and extending across the passageway. Ice pieces conveyed from the inlet end of the splitter to the outlet end of the splitter are split into smaller pieces by the blades and exit the outlet of the second housing in the form of the smaller pieces. The blades may be fixed or rotational relative to each other to adjust the orientation of the blades relative to each other.

### FIELD

This disclosure relates to the field of dry ice blast cleaning systems. More particularly, the present disclosure relates to a dry ice blast cleaning system having a dry ice feed apparatus and a method for feeding dry ice pieces within a dry ice blast cleaning system. More particularly, the present invention relates to an ice splitter for a dry ice blasting system.

### BACKGROUND

The statements in this section merely provide background information related to the present disclosure and may not constitute prior art.

The use of dry ice for blast cleaning is well known in the art. In dry ice blast cleaning systems, pieces of dry ice (solidified Carbon Dioxide, CO2) are drawn into a fluid stream (typically compressed air) and moved through a blast gun. The pieces of dry ice are entrained into the gas stream and propelled out of the gun to impact against the surface to be cleaned. After the dry ice pieces collide with the surface, the dry ice pieces sublimate into gaseous CO2 and become part of the ambient atmosphere. Generally, the only remaining residue from this process is the removed surface debris.

The sizing of the dry ice pieces used in the dry ice blast cleaning system varies with the method used to produce the pieces and the items to be cleaned. One of the most common sizes approximates the size of rice grains. Another form or size of dry ice pieces are rod-shaped dry ice generally called nuggets. Dry ice nuggets generally have a larger size than previously used dry ice pieces but have a much longer shelf life than smaller-sized forms of dry ice pieces available in the market. The problem presented by the use of dry ice nuggets is that their size must be reduced for efficient use in a dry ice blast cleaning system. However, efforts to break apart the dry ice pieces can lead to sublimation, similar to the effect caused when the pieces impact the workpiece.

There remains a need in dry ice blasting systems to reduce the size of dry ice pieces without substantially sublimating the pieces.

### SUMMARY

A splitter for splitting ice pieces of an ice blasting system is provided, the splitter comprising: a first housing defining a central axis and having an inlet end and an outlet end and defining a cavity therein; a second housing sized and configured to mate with the first housing and having an inlet and outlet end, wherein the inlet end of the second housing mates with the outlet end of the first housing; a plurality a blade rings aligned axially with each other and disposed within the cavity of the housing and between the inlet end of the first housing and the inlet end of the second housing; wherein each of the blade rings includes a plurality of blades extending across an opening formed through the blade rings; wherein each of the blades includes an inlet side having a sharper edge than an outlet side thereof; wherein ice pieces conveyed from the inlet end of the splitter to the outlet end of the splitter are split into smaller pieces by the blades and exit the outlet of the second housing in the form of the smaller pieces.

In one aspect, at least one of the blade rings is adjustable to rotationally orient the blades about the central axis relative to the blades of the other blade rings.

In one aspect, two of the blade rings are rotationally fixed relative to each other.

In one aspect, the second housing has a reduced outlet size relative to an inlet size of the first housing.

In one aspect, the ice pieces are dry ice pieces and are not sublimated in response to impact with the blades.

In one aspect, the blades of one blade ring are fixedly aligned perpendicular to the blades of another ring.

In one aspect, the blades of one blade ring are fixedly aligned at an oblique angle relative to the blades of another ring.

In one aspect, the first and second housing are aluminum and the blades are spring steel.

In one aspect, the system includes at least one fitting threadingly connected to the first and/or second housing.

In another aspect, a method of splitting ice pieces is provided, the method comprising: receiving ice pieces at an inlet of an ice splitter housing; conveying the ice pieces through an axial passageway extending through the housing; impacting the ice pieces against a leading edge of at least one first blade disposed at a first axial location and extending across the passageway; impacting the ice pieces against a leading edge of at least one second blade disposed a second axial location downstream from the first axial location and extending across the passageway; defining smaller ice pieces following the impacting steps; expelling the smaller ice pieces from an outlet of the splitter.

In one aspect, the first blade is arranged at a transverse angle relative to the second blade.

In one aspect, the transverse angle is a perpendicular angle.

In one aspect, the transverse angle is an oblique angle.

In one aspect, the method includes adjusting an orientation of the first blade relative to the second blade while the blades remain in the housing during the conveying step.

In one aspect, the smaller ice pieces are expelled from the splitter in a substantially non-sublimated condition.

In another aspect, a splitter for splitting ice pieces of an ice blasting system is provided, the splitter comprising: a splitter housing defining a passageway and a central axis and having an inlet end and an outlet end and defining a cavity therein; a plurality of first blades at a first axial location within the cavity and extending across the passageway; a plurality of second blades at a second axial location downstream from the first axial location and within the cavity and extending across the passageway; wherein ice pieces conveyed from the inlet end of the splitter to the outlet end of the splitter are split into smaller pieces by the blades and exit the outlet of the second housing in the form of the smaller pieces.

In one aspect, the first blades are arranged at a transverse angle relative to the second blades.

In one aspect, the first blades are rotationally fixed relative to the second blades.

In one aspect, the first blades are rotationally adjustable relative to the second blades.

In one aspect, a plurality of third blades are disposed axially downstream from the second blades, wherein the third blades are arranged perpendicular relative to the second blades and fixed relative to the second blades.

This summary is provided merely to introduce certain concepts and not to identify key or essential features of the claimed subject matter. The substance and advantages of the present invention will become increasingly apparent by reference to the following drawings and the description.

### BRIEF DESCRIPTION OF THE SEVERAL VIEWS OF THE DRAWINGS

One or more embodiments will now be described, by way of example, with reference to the accompanying drawings, in which:

FIG. 1 is a top perspective view of a splitter for an ice blast cleaning system;

FIG. 2 is an exploded top perspective view of the splitter;

FIG. 3 is an enlarged exploded top perspective view of the inlet end of the splitter;

FIG. 4 is an enlarged exploded top perspective view of the outlet end of the splitter;

FIG. 5 is an enlarged exploded bottom perspective view of the inlet end of the splitter;

FIG. 6 is an enlarged exploded bottom perspective view of the outlet end of the splitter;

FIG. 7 is another enlarged exploded top perspective view of the inlet end of the splitter;

FIGS. 8A and 8B is a top end view of the splitter, showing two different positions;

FIG. 9 is an enlarged exploded top perspective view of the blade rings of the splitter; and

FIG. 10 is an enlarged exploded bottom perspective view of the blade rings of the splitter.

### DETAILED DESCRIPTION OF THE INVENTION

Various embodiments of the present invention will be described in detail with reference to the drawings, where like reference numerals represent like parts and assemblies throughout the several views. Reference to various embodiments does not limit the scope of the invention. Additionally, any examples set forth in this specification are not intended to be limiting and merely set forth some of the many possible embodiments for the claimed invention.

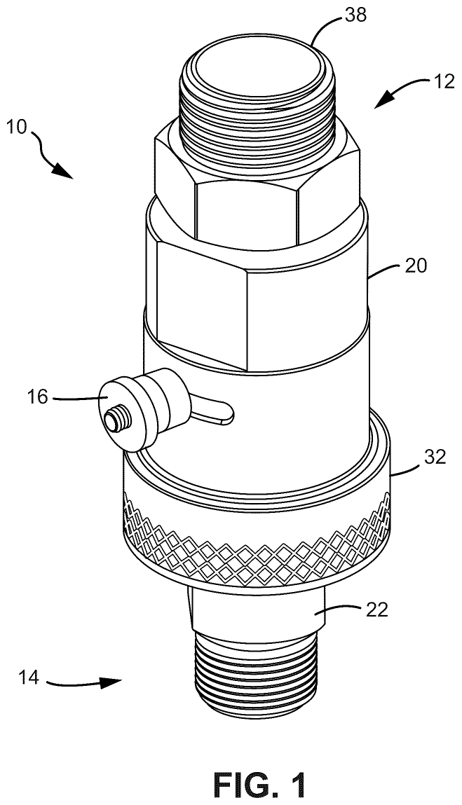

Referring now to the drawings, wherein the depictions are for the purpose of illustrating certain one embodiments only and not for the purpose of limiting the same, FIG. 1 shows a dry ice splitter assembly 10 having an inlet end 12 and an outlet end 14. The dry ice splitter receives dry ice nuggets or pieces and finely cuts the nuggets or pieces to reduce the size of the dry ice without sublimating the pieces.

The dry ice splitter 10 is configured to be attached to dry ice blasting system (not shown), such as the system disclosed in co-owned U.S. Pat. No. 9,700,989, filed Mar. 12, 2015, issued Jul. 11, 2017, titled “Dry Ice Blast Cleaning System and Method for Operating the Same,” the entire content of which is incorporated by reference in its entirety.

The splitter 10 receives dry ice from such a system or another system suitable to convey dry ice nuggets or pieces to the inlet end 12 of splitter 10, split the ice pieces, and convey the smaller, non-sublimated ice pieces to and through the outlet end 14 of the dry ice splitter 10.

Splitter 10 includes a knob 16 accessible on the outside of the system configured to adjust the orientation of internal blades about the central axis of the splitter 10, as further shown and described below.

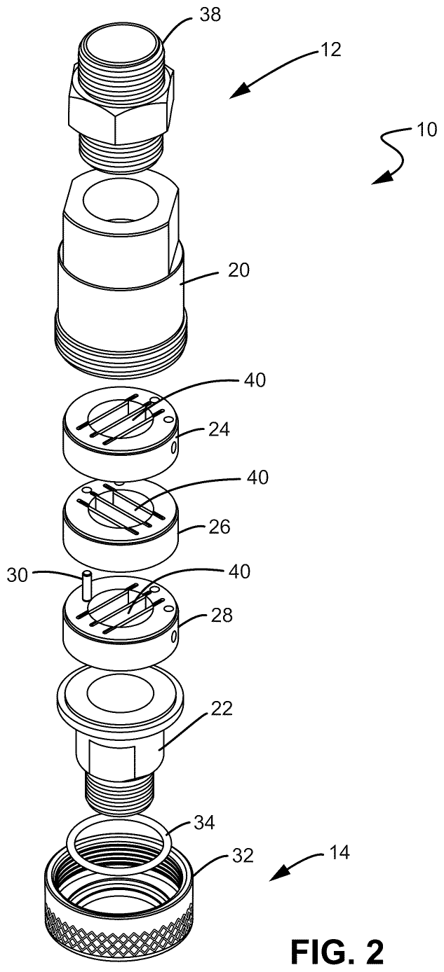

FIG. 2 illustrates an exploded view of the splitter 10. The inlet end 12 is at the top of FIG. 2, and represents the machine side of the splitter 10, being the side that receives the larger ice pieces from the dry ice blasting system and the store of dry ice therein. The bottom of FIG. 2 is the outlet end 14 of the splitter 10. For the purposes of discussion relative to the Figures, reference will be made to upper and lower, corresponding to the machine side and inlet end being at the top of FIG. 2, and the outlet end being at the bottom of FIG. 2. It will be appreciated that manipulating of the splitter will result in various orientations during assembly, storage, or use. The “upper” components may also be referred to as “first” and the “lower” components may also be referring to as “second.”

Splitter 10 includes upper housing 20 and lower housing 22. Upper housing 20 includes an internal cavity sized to receive three blade rings 24, 26, and 28. It will be appreciated that the total number of blade rings may vary, and that the size and shape of the upper housing 20 may correspondingly vary. For example, additional blade rings of the same size shown in FIG. 2 may be housed within an internal cavity of an upper housing that is longer than that shown.

The upper housing 20 has an outlet end at the bottom thereof that mates with the inlet end (at the top) of the lower housing 22. The lower housing 22 may include a stepped surface at its inlet end that is received in the outlet end of the upper housing 20, to align the upper housing 20 axially with the lower housing 22 when assembled.

The blade rings include upper ring 24, middle ring 26, and lower ring 28. In one aspect, middle ring 26 and lower ring 28 may be fixed rotationally relative to each other, such that the blades contained therein are fixed perpendicularly relative to each other. Upper ring 24 may be rotationally adjustable relative to middle ring 26 and lower 28, thereby varying the angle of the blades of upper ring 24 relative to the fixed perpendicular arrangement of the middle ring 26 and lower 28.

Each of the blade rings may have a stepped surface at the upper inlet end and a recessed surface at the lower outlet end such that the blade rings may nest together when assembled. However, it will be appreciated that other nesting arrangements may be provided, such as a recess at the top and stepped surface at the bottom of each of the rings. In one aspect, the rings may all have the same size, shape, and features, allowing different rings to fixed relative to each other and/or rotation relative to each other, if desired according to the needs of the user. In one aspect, the rings have flat upper and lower surfaces, with axial alignment being provided by the cavity in which they are received.

The middle ring 26 and lower ring 28 may be fixed relative to each other via an axially extending pin 30 or the like. However, other methods of fixing the rings relative to each other may also be used. For instance, an outer profile of the stepped surface and corresponding recess may be used, such as a polygonal outer profile like a hex profile or octagonal profile. In another aspect, an adhesive may be applied between the rings.

Upper housing 20 may include external threads at the outlet end thereof. A lower sleeve 32 is positioned around the lower housing and includes internal threads that mate with the upper housing 20 to clamp the upper housing 20 to the lower housing 22 and secure them together. An o-ring gasket 34 is disposed axially between the lower sleeve 32 and a radial flange 22a of the lower housing 22. The inlet end of the upper housing 20 includes internal threading that mates with external threading of upper fitting 38. The upper fitting is configured for attachment to the supply tube that conveys the drive ice pieces or nuggets.

Each of the blade rings includes a plurality of blades 40 attached therein. The blade rings may include slots formed therein on opposite sides of a central opening, with the opposite ends of the blades 40 being received in the slots and extending across the central opening. As shown, each of the blade rings includes three blades 40, but other quantities of blades 40 may be used in each ring. In one aspect, the same number of blades 40 are used in each of the rings. In another aspect, one of the rings may have a first quantity of blades 40 and one or more of the other rings may have different quantity of blades 40. In one aspect, each ring may have a different quantity of blades 40. For the purposes of discussion, the three-blade arrangement shown will be referenced.

At the upper or inlet side 42 of each of the blades 40 (and blade rings), the blades 40 have a narrow or sharp edge, similar to a razor blade. At the opposite, lower, or outlet side 44 of the blades, the blades 40 may have a blunt or flat end. The outlet side 44 is the side received and held in the slots of the blade rings. Put another way, the blades 40 may be dropped into the slots. The blades 40 may be secured in the slots. The inlet side 42 of the blades 40 is the side that is impacted by the ice pieces as they are being conveyed through the splitter 10. The sharp edge at the inlet side 42 thereby operates to slice and split the ice without sublimating the ice, thereby allowing the ice to perform its abrasive function as desired.

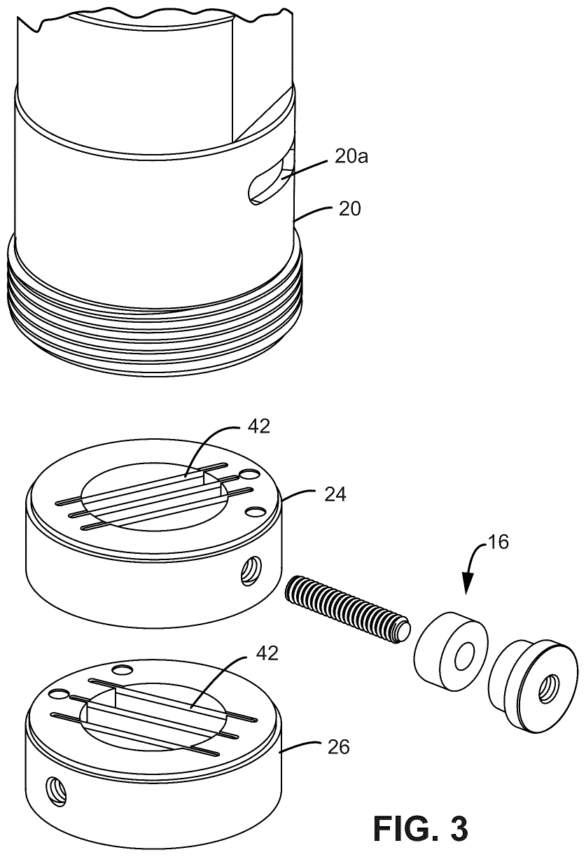

With reference now to FIG. 3, an enlarged exploded view showing the inlet end of the exploded splitter 10 is provided and illustrates more clearly the upper blade ring 24 positioned above the middle blade ring 26. The upper blade ring 24 is the rotationally adjustable blade ring, and includes a recess for receiving a threaded pin or the like, which is connected to the adjustment knob 16 at the opposite end. The upper housing 20 includes a slot 20a through which the threaded pin extends, thereby providing for rotational adjustment of the upper ring 24 via sliding movement of the knob 16 along the slot 20a. Rotating the upper ring 24 relative to the other rings can therefore align the blades 40 of the upper ring at an angle relative to each of the perpendicularly arranged blades 40 of the other rings.

FIG. 3 also illustrates in more detail the stepped upper surface of the rings 24 and 26, thereby permitting nesting of the rings when assembled within the upper housing 20.

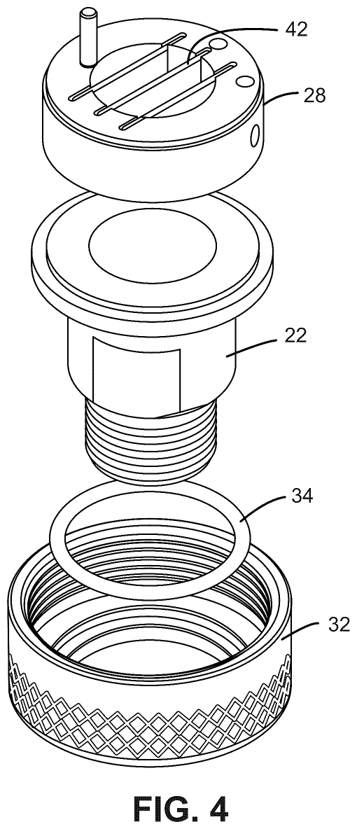

FIG. 4 illustrates an enlarged exploded view showing the outlet end of the exploded splitter 10, illustrating more clearly the lower ring 28, the lower housing 22, and the sleeve 32. The lower housing 22 includes external threading at its lower end for attachment of further components to the outlet end of the splitter 10. The stepped upper surface of the lower housing 22 is shown, which receives the bottom of the lower ring 28 to axially align the lower ring 28. The sleeve 32 may pass over the bottom of the lower housing and up into engagement with the upper housing 20 to secure the upper housing 20 to the lower housing 22. The sleeve 32 may include a stepped lower end, sized and configured to mate with the radial flange of the upper end of the lower housing 22, as well as receiving the o-ring gasket 34 in the recessed stepped surface. The upper surfaces of the rings 24, 26, and 28 each show a hole for receiving a setting pin to hold the relative location of one ring to another. The upper ring 24, which is rotatable, will not receive a pin to allow for rotation. The middle ring 26 and lower ring 28 may receive a pin between the lower and upper surface, respectively, to set the blades 40 at a fixed angle. Multiple holes may be disposed in the upper surfaces to allow for different fixed positions and different fixed angles. The arrangement and placement of the holes may be provided according to the desired relative angle. Additional holes may be provided to provide for additional setting possibilities.

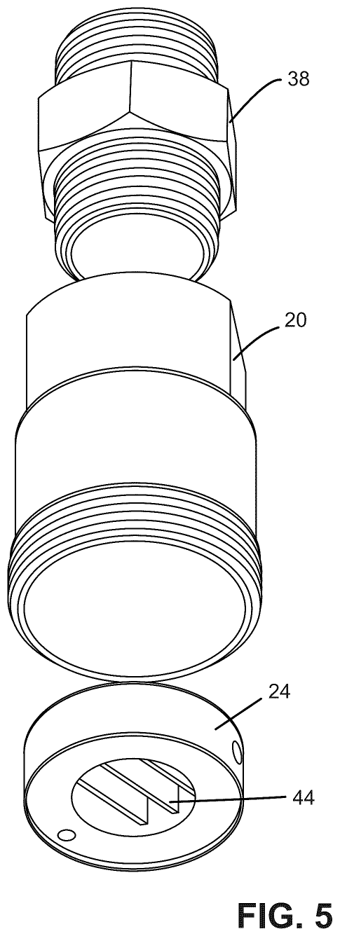

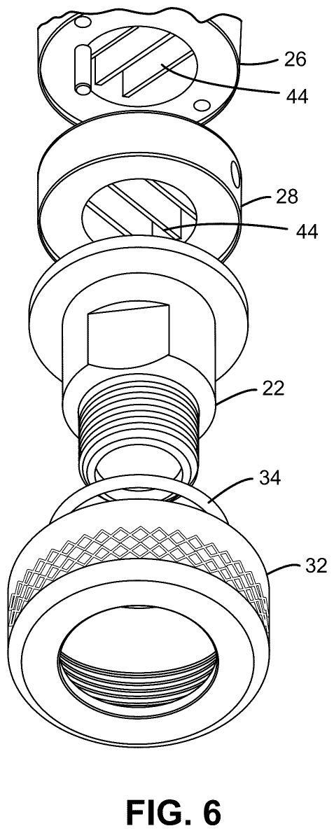

FIGS. 3 and 4 illustrate the exploded view from the top. FIGS. 5 and 6 illustrate similar exploded views from the bottom. Thus, FIGS. 5 and 6 illustrate the recess into which the stepped upper surfaces of the rings are received, as well as the blunt ends 44 of the blades. As shown the blunt/bottom ends of the blades 40 are showed set back from the bottom of the blade rings 24, 26, 28. Thus, an axial space is defined between the bottoms of the blades 40 and the tops of the axially adjacent blades 40 at each ring interface.

FIG. 5 illustrates the inlet end/machine end/upper end of the splitter 10. The recessed lower surface of the upper ring 24 is shown in FIG. 5, which is received on the stepped upper surface of the middle ring 26 for nesting the rings together when assembled. A hole is also illustrated on the bottom surface of upper ring 24, but this hole is not used for the upper ring 24 because the upper ring is rotatable relative to the middle ring. If rotationally fixing the upper ring 24 is desired, a pin can be provided to rotationally fix the upper ring 24 relative to the middle ring 26.

FIG. 6 illustrates the outlet end/lower end of the splitter 10 assembly. Middle ring 26 and lower ring 28 are shown from the bottom, each of which show the recessed surface for nesting and a hole for receiving a pin 46 to fix the relative position of the rings. The pin 46 may be disposed between the middle and lower rings 26, 28 to fix the orientation of these rings relative to each other.

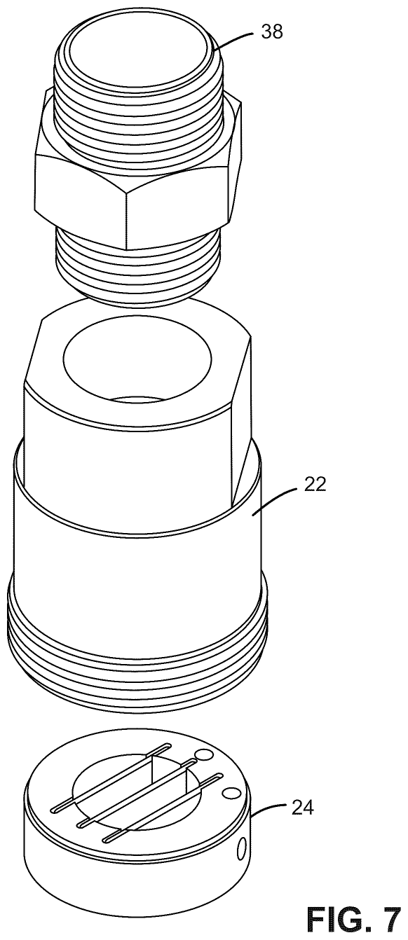

FIG. 7 illustrates another exploded view of the upper end of the splitter, illustrating fitting 38 having external threads at both the upper inlet end and the outlet end, with the outlet end received in the bore of the upper housing 20 (which may include corresponding internal threads). The inlet end of the fitting 38 also has external threads and may be attached to components upstream of the blasting system having the ice supply.

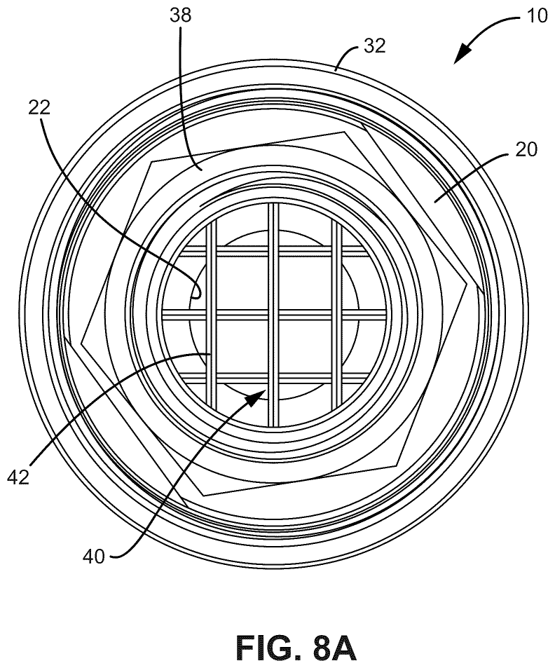

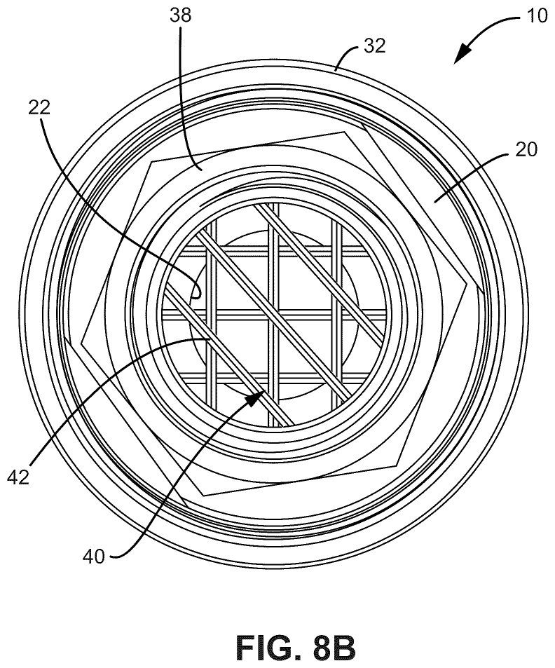

FIGS. 8A and 8B illustrates a top view, looking axially down the splitter from the inlet end toward the outlet end. The fitting 38 and upper housing 20 are visible in this view, as well as outer ring of the lower sleeve 32. The outlet end of the lower housing 22 is also shown inside the central passageway of the splitter 10.

The blades 40 of the rings 24, 26, and 28 are shown in this view, in particular the inlet side 42 having the sharp edge. The blades 40 are arranged perpendicular to each other, with the blades 40 of the adjustable ring aligned and parallel to those of the bottom ring 28 in this view (which are accordingly not visible as they are overlapped by the blades 40 of the upper ring 24). The middle ring 26 is arranged perpendicular to the upper ring 24 and lower ring 28, and therefore these blades 40 are visible and extend across the passageway perpendicular to the visible blades 40 of the upper ring 24. Adjustment of the upper ring 24 will cause the visible blades 40 (shown in FIG. 8A extending vertically in the figure) to be positioning at an oblique angle relative to the blades 40 of the other rings, and the blades 40 of the lower ring 28 would be visible in a similar view and remain extending vertically in this figure. FIG. 8B shows the upper ring 24 rotated relative to FIG. 8A. The blades 40 below the upper ring are still positioned parallel to each other in this arrangement. It will be appreciated that other fixed positions and other rotational positions may also be provided.

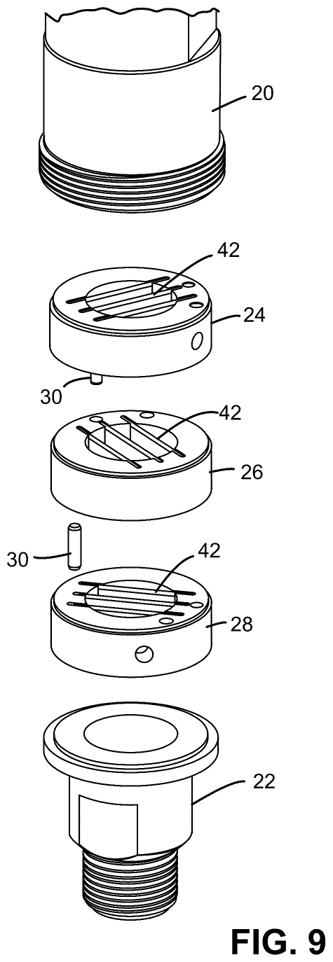

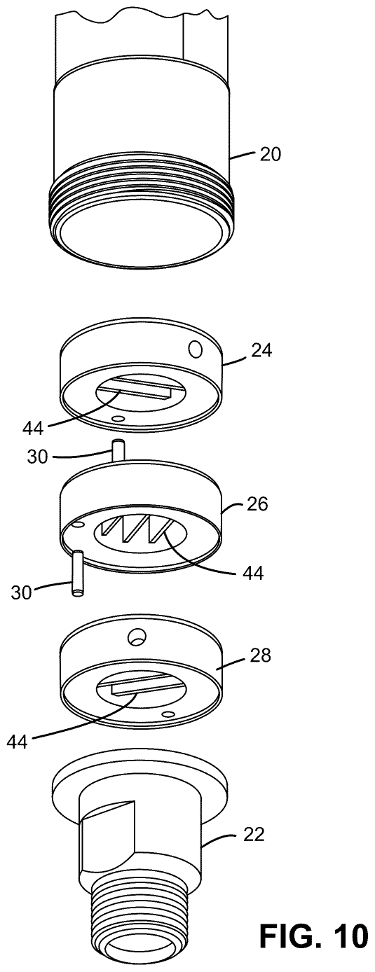

FIGS. 9 and 10 illustrate additional exploded perspective views from both the top and bottom of the blade rings 24, 26, and 28. In these views an additional pin 30 is provided, which may be used to fix all three rings together to be fixed relative to each other. In this view, the bottom ring is arranged at a 45 degree angle relative to the middle ring 26, and the top ring 24 is arranged perpendicular to the middle ring 26. In this arrangement, the knob 16 may be excluded because the upper blade ring 24 does not rotate.

It will be appreciated that other fixed positions of two or more of the rings relative to each other may be used, with optional selective rotation of the top ring 24 relative to the bottom two rings when the top ring 24 is not fixed. For instance, in one aspect, the middle and bottom rings 26, 28 may be fixed to each other in a parallel arrangement rather than perpendicular or at an oblique angle, with the top ring being adjustable to be parallel, perpendicular, or at an oblique angle relative to the aligned blades of the middle and bottom rings.

Thus, in view of the above, the splitter 10 may be placed along the dry ice blasting system such that dry ice pieces traveling through the dry ice blasting system will travel through the splitter 10 and contact the sharp edges of the blades 40 to be split into smaller pieces. The size of the resulting pieces may be selected by fixing the blade rings to predefined positions, or they may be adjustable and adjusted during use by rotating the upper ring 24 during or between uses. In one aspect, the splitter 10 may be arranged upstream of the blasting gun (creating smaller piece that travel through the hose and/or gun handle of the blast system) or downstream from the blasting gun (creating smaller pieces as they exit the nozzle of the blasting gun).

The above system 10 may be used in a variety of dry ice blasting systems, including various types of storage containers, dry ice piece size, etc. The splitter 10 may be added easily to existing systems in a retrofit arrangement or as part of an overall system. The fitting 38, for example, can be switched out to include matching threads at its inlet end for attachment to various systems.

The number of rings and length/size of the splitter 10 may be varied. The number of blades 40 per ring may also be varied, as well as the overall length/height of the blades.

In one aspect, the housings are aluminum, the blades are spring steel, and the fittings are stainless steel. The blade rings may also be aluminum. Of course, other materials could be used and still provide the splitting functionality of the splitter 10.

The present disclosure is also directed to a method for operating the above described splitter 10.

In one aspect, a method of splitting ice pieces is provided, the method comprising: receiving ice pieces at an inlet of an ice splitter housing; conveying the ice pieces through an axial passageway extending through the housing; impacting the ice pieces against a leading edge of at least one first blade disposed at a first axial location and extending across the passageway; impacting the ice pieces against a leading edge of at least one second blade disposed a second axial location downstream from the first axial location and extending across the passageway; defining smaller ice pieces following the impacting steps; expelling the smaller ice pieces from an outlet of the splitter.

In one aspect, the first blade is arranged at a transverse angle relative to the second blade.

In one aspect, the transverse angle is a perpendicular angle.

In one aspect, the transverse angle is an oblique angle.

In one aspect, the method includes adjusting an orientation of the first blade relative to the second blade while the blades remain in the housing during the conveying step.

In one aspect, the smaller ice pieces are expelled from the splitter in a substantially non-sublimated condition.

It will be appreciated that the above method may be further modified or revised to include the various features and functionality of the splitter 10 described above.

In the foregoing description, various features of the present invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated by reference herein in their entirety, with each claim standing on its own as a separate embodiment of the present invention.

It is intended that the foregoing description be only illustrative of the present invention and that the present invention be limited only by the hereinafter appended claims.

What is claimed is:

1. A splitter for splitting ice pieces of an ice blasting system, the splitter comprising:
a first housing defining a central axis and having an inlet end and an outlet end and defining a cavity therein;
a second housing sized and configured to mate with the first housing and having an inlet and outlet end, wherein the inlet end of the second housing mates with the outlet end of the first housing;
a plurality a blade rings aligned axially with each other and disposed within the cavity of the housing and between the inlet end of the first housing and the inlet end of the second housing;
wherein each of the blade rings includes a plurality of blades extending across an opening formed through the blade rings;
wherein each of the blades includes an inlet side having a sharper edge than an outlet side thereof;
wherein ice pieces conveyed from the inlet end of the splitter to the outlet end of the splitter are split into smaller pieces by the blades and exit the outlet of the second housing in the form of the smaller pieces.

2. The splitter of claim 1, wherein at least one of the blade rings is adjustable to rotationally orient the blades about the central axis relative to the blades of the other blade rings.

3. The splitter of claim 2, wherein two of the blade rings are rotationally fixed relative to each other.

4. The splitter of claim 1, wherein the second housing has a reduced outlet size relative to an inlet size of the first housing.

5. The splitter of claim 1, wherein the ice pieces are dry ice pieces and are not sublimated in response to impact with the blades.

6. The splitter of claim 1, wherein the blades of one blade ring are fixedly aligned perpendicular to the blades of another ring.

7. The splitter of claim 1, wherein the blades of one blade ring are fixedly aligned at an oblique angle relative to the blades of another ring.

8. The splitter of claim 1, wherein the first and second housing are aluminum and the blades are spring steel.

9. The splitter of claim 1, further comprising at least one fitting threadingly connected to the first and/or second housing.

10. A method of splitting ice pieces, the method comprising:
receiving ice pieces at an inlet of an ice splitter housing;
conveying the ice pieces through an axial passageway extending through the housing;
impacting the ice pieces against a leading edge of at least one first blade disposed at a first axial location and extending across the passageway;
impacting the ice pieces against a leading edge of at least one second blade disposed a second axial location downstream from the first axial location and extending across the passageway;
defining smaller ice pieces following the impacting steps;
expelling the smaller ice pieces from an outlet of the splitter.

11. The method of claim 10, wherein the first blade is arranged at a transverse angle relative to the second blade.

12. The method of claim 11, wherein the transverse angle is a perpendicular angle.

13. The method of claim 11, wherein the transverse angle is an oblique angle.

14. The method of claim 11, further comprising adjusting an orientation of the first blade relative to the second blade while the blades remain in the housing during the conveying step.

15. The method of claim 10, wherein the smaller ice pieces are expelled from the splitter in a substantially non-sublimated condition.

16. A splitter for splitting ice pieces of an ice blasting system, the splitter comprising:
a splitter housing defining a passageway and a central axis and having an inlet end and an outlet end and defining a cavity therein;
a plurality of first blades at a first axial location within the cavity and extending across the passageway;
a plurality of second blades at a second axial location downstream from the first axial location and within the cavity and extending across the passageway;
wherein ice pieces conveyed from the inlet end of the splitter to the outlet end of the splitter are split into smaller pieces by the blades and exit the outlet of the second housing in the form of the smaller pieces.

17. The splitter of claim 16, wherein the first blades are arranged at a transverse angle relative to the second blades.

18. The splitter of claim 17, wherein the first blades are rotationally fixed relative to the second blades.

19. The splitter of claim 17, wherein the first blades are rotationally adjustable relative to the second blades.

20. The splitter of claim 17, wherein a plurality of third blades are disposed axially downstream from the second blades, wherein the third blades are arranged perpendicular relative to the second blades and fixed relative to the second blades.
